(19) United States
(12) Patent Application Publication
(10) Pub. No.: US 2007/0295186 A1
(43) Pub. Date: Dec. 27, 2007

(54) PEG FOR STRINGED INSTRUMENT

(75) Inventor: Takao Goto, Gunma (JP)

Correspondence Address: THOMPSON HINE L.L.P.;Intellectual Property Group, P.O. BOX 8801, DAYTON, OH, 45401-8801, US

(73) Assignee: GOTOH GUT CO., LTD., Gunma (JP)

(21) Appl. No.: 11/753,920

(22) Filed: May 25, 2007

(30) Foreign Application Priority Data
Jun. 9, 2006 (JP) 2006-160798

(51) Int. Cl. G10D 3/14

(52) U.S. Cl. 84/304

(57) ABSTRACT

A peg for a stringed instrument has a knob made of metal which has an internal hollow portion. The knob is light in weight and has a reduced wall thickness because the hollow portion is formed therein. Therefore, the responses of vibrations of strings during performances are fast, and tone and afterglow of sounds are good. A high-quality appearance is provided by the metal knob. A smaller sprue may be used because a smaller amount of melted metal is required when the knob is cast, and the mark of the sprue formed on a surface of a molded knob is therefore be smaller when the melted metal is injected through the sprue. Formation of blowholes caused by gas contained in the knob molded by casting can be reduced because the wall of the knob is thin.

### TECHNICAL FIELD

The present invention relates to a peg for a stringed instrument such as a guitar, and specifically, relates to a knob of a peg.

### BACKGROUND ART

A stringed instrument such as a guitar comprises pegs for tuning strings. For example, Japanese Utility Model Application Laid-Open No. 56-102589 discloses a peg comprising a body provided at a head of a stringed instrument, a worm gear rotatably provided at the body, a knob provided at an end portion of the worm gear for rotating the worm gear, and a winding shaft connected to the worm gear in contact with a worm wheel. In such a peg, strings are secured to the winding shaft by winding, and the strings are wound or unwound by rotating the knob, so that tuning may be performed.

Most of the pegs used for stringed instruments, specifically those used for electrical guitars and folk guitars, are made of metal and may, for example, be manufactured by zinc die-casting. In manufacturing knobs, a mold 100, consisting of a split mold 101 and a split mold 102 shown in FIGS. 7A and 7B may be used. It should be noted that FIG. 7A shows a cross section of an upper side of the mold 100, and FIG. 7B is a sectional side view taken on line A-A of FIG. 7A. In the mold 100, melted metal is injected through a sprue 100b of the split mold 102, and gas inside of a cavity 100a is discharged from a gas exhaust port 100c of the split mold 101.

Pegs made of metal are heavy, and the responses of vibrations of strings are thereby slow during performances, and tone and afterglow of sounds are insufficient. A mark at the line of separation of the split molds 101 and 102 and a mark of the sprue 100b are formed on the side of the knob when the above knob is cast, and the marks of the knobs for middle-grade and high-grade manufactured articles must be removed by hand using an sand paper and a surface thereof requires hand polishing (hand buffing). A method may be used in which many knobs are polished at one time by barrel polishing, in which a rotating barrel is used, instead of hand polishing. However, many scratches are formed because the knobs are heavy and strike each other. Moreover, gas may be contained in the inside of a knob, leading to the formation of blowholes, because the knob has a thick wall. Therefore, the gas in such blowholes escapes during plating after casting, and defects in coating occur.

Thus, a peg of high quality and yielding superior sound quality cannot be obtained when a conventional metal knob as described above is used. It should be noted that a plastic knob which is light in weight and does not have problems related to casting may be used instead, but such a knob does not provide the high-quality appearance which is desirable for stringed instruments.

### SUMMARY OF THE INVENTION

An object of the present invention is to provide a peg for a stringed instrument which is light in weight and which yields superior sound quality as well as having high quality.

The present invention provides a peg for a stringed instrument, comprising a body mounted at a head of the stringed instrument, a worm gear rotatably provided at the body, a metal knob provided at an end portion of the worm gear for rotating the worm gear, and a winding shaft connected with the worm gear in contact with a worm wheel, and the inside of the knob is hollow.

In a peg for a stringed instrument of the present invention, the knob is light in weight and has a reduced wall thickness because the inside of the metal knob is hollow. Therefore, responses of vibrations of strings during performances are fast, and tone and afterglow of sounds are good. A high-quality appearance is obtained because the knob is made of metal. Moreover, the amount of metal material used to make the knob can be reduced, and the manufacturing cost therefor can thereby be reduced. A smaller sprue may be used because only a small amount of melted metal is required when the knob is cast, and the mark of the sprue formed on a surface of a molded knob can therefore be smaller when the melted metal is injected through the sprue. Furthermore, formation of blowholes caused by gas contained in a knob molded by casting can be inhibited because the wall of the knob is thin. Accordingly, the amount of gas escaping from the inside of the knob is decreased during plating after casting, and the formation of defects in the coating can be inhibited. In addition, when polishing is performed by barrel polishing, the formation of scratches can be inhibited because the knobs are light in weight, even if the knobs strike each other as they do conventionally. Therefore, a large number of knobs may be polished in one barrel polishing, and the manufacturing cost therefor can be further reduced.

Various compositions may be used in order to easily manufacture a knob of a peg. For example, a knob may comprise a shell which is hollow and has an opening at an end portion, and a cap which is removably provided at the opening of the shell.

According to such an embodiment, the shell and the cap are individually cast when the knob is manufactured. A mold comprising a lower split mold and an upper split mold may be used. A cavity is formed by providing the upper split mold on the lower split mold when the shell is cast. The lower split mold comprises a concave portion having a shape corresponding to the outer peripheral surface of the shell. The upper split mold comprises a convex portion having a shape corresponding to the inner peripheral surface of the shell. The convex portion of the upper split mold is provided opposing the concave portion of the lower split mold when the cavity is formed. In this case, a sprue is provided at one portion where a bottom surface of the side of the shell is formed on the upper split mold, and a gas exhaust port is provided at the other portion thereof.

The shell may be formed by using the above-described mold and injecting melted metal through the sprue. In this case, a separation line of the split molds is formed on the bottom surface of the side of the shell, and it is thereby not conspicuous. The separation line formed at this time has an edge shape that is removable by barrel polishing. Moreover, the sprue may be provided at a location that is not conspicuous, whereby the mark of the sprue is not conspicuous.

The knob may be provided with a screw. In this case, holes are formed in each of the shell and the cap of the knob, and the screw removably secures the shell and the cap to an end portion of the worm gear through the holes thereof. Specifically, the end portion of the worm gear is inserted into the hole of the cap and is threadably mounted with the screw. In this case, the cap is preferably provided with a boss which protrudes to the inside of the shell and has a hole. Moreover, the shell is preferably provided with a convex portion which fits to the boss.

According to the peg for a stringed instrument of the present invention, the knob is light in weight and has a reduced wall thickness, because the inside of the metal knob is hollow. Therefore, the amount of material used in casting is decreased, articles which have defects such as scratches made by gas escaping during plating and handling are greatly reduced, responses of vibrations of strings during performances are fast, and tone and afterglow of sounds are good.

### BRIEF DESCRIPTION OF DRAWINGS

FIG. 1 is a side view showing a schematic structure of a peg of an embodiment of the present invention.

FIGS. 2A to 2C show schematic structures of a shell of a knob of an embodiment of the present invention, wherein FIG. 2A is a cross section taken on line A-A of FIG. 2C, FIG. 2B is a cross section taken on line B-B of FIG. 2C, and FIG. 2C is a top view.

FIGS. 3A to 3C show schematic structures of a cap of the knob of an embodiment of the present invention, wherein FIG. 3A is a cross section taken on line A-A of FIG. 3C, FIG. 3B is a cross section taken on line B-B of FIG. 3C, and FIG. 3C is a top view.

FIG. 4 is a sectional side view of a mold for explaining a manufacturing method of a shell of the knob shown in FIGS. 2A to 2C.

FIG. 5 is a side view showing a schematic structure of another example of a peg of an embodiment of the present invention.

FIGS. 6A to 6C are schematic structures showing a cap of the peg of an embodiment of the present invention, wherein FIG. 6A is a cross section taken on line A-A of FIG. 6C, FIG. 6B is a cross section taken on line B-B of FIG. 6C, and FIG. 6C is a top view.

FIGS. 7A and 7B are drawings for explaining a manufacturing method of a conventional knob, wherein FIG. 7A is a sectional top view of a mold and FIG. 7B is a sectional side view taken on line A-A of FIG. 7A.

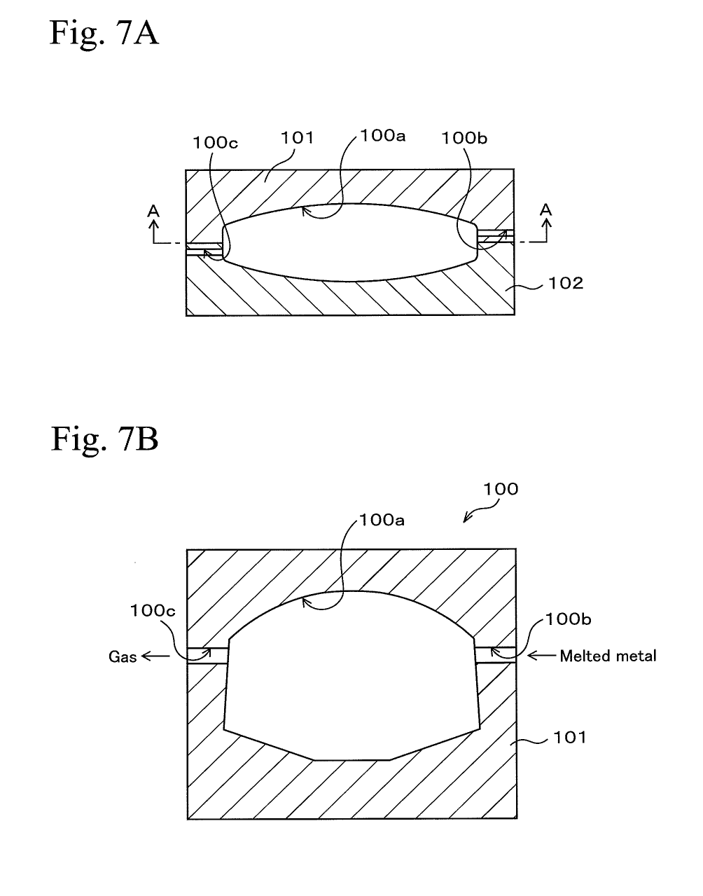

### EMBODIMENTS OF THE INVENTION

### 1. Compositions of Embodiments

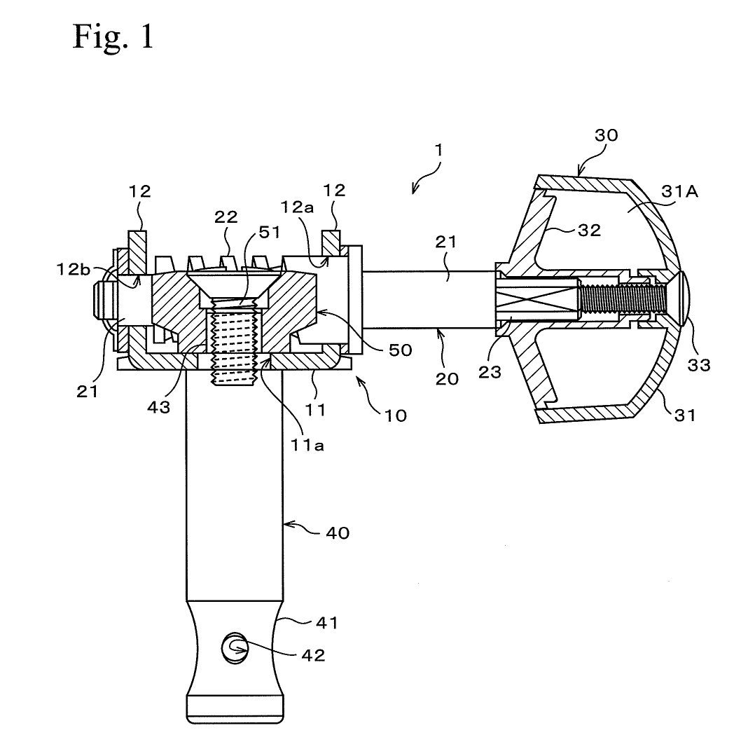

An embodiment of the present invention will be explained with reference to the drawings. FIG. 1 is a side view showing a schematic structure of a peg 1 of an embodiment of the present invention. FIG. 1 shows an inside of a body 10 and a knob 30 in cross section. A cover which covers the body 10 is omitted in FIG. 1.

In FIG. 1, reference numeral 10 indicates a body provided at a head of a stringed instrument, reference numeral 20 indicates a worm gear rotatably supported by the body 10, reference numeral 30 indicates a knob provided to an end portion of the worm gear 20 and internally having a hollow portion 31A, reference numeral 40 indicates a winding shaft for winding strings, and reference numeral 50 indicates a worm wheel fitted to the worm gear 20. The knob 30 is described in detail, and description of other components and functions are omitted.

The body 10 is basically composed of a flat base 11 and a bearing 12 that stands at both sides of the base 11. The base 11 is formed with a supporting hole 11a which rotatably supports the winding shaft 40. One of the bearing 12 is formed with a large hole 12a, and the other bearing 12 is formed with a small hole 12b.

The worm gear 20 is rotatably supported at the large hole 12a and the small hole 12b of the bearing 12. The worm gear 20 is formed with a worm shaft 21 which is formed with a worm 22. The top of the worm shaft 21 is formed with an attaching portion 23 which has a smaller diameter than that of the worm shaft 21. The center of the top of the attaching portion 23 is formed with a screw hole (not shown).

The knob 30 comprises a shell 31 which is hollow and has an opening at an end portion, and comprises a cap 32 which is removably provided at the opening of the shell 31. The shell 31 is covered with the cap 32 at the opening and is removably secured to the attaching portion 23 of the worm shaft 21 by a screw 33.

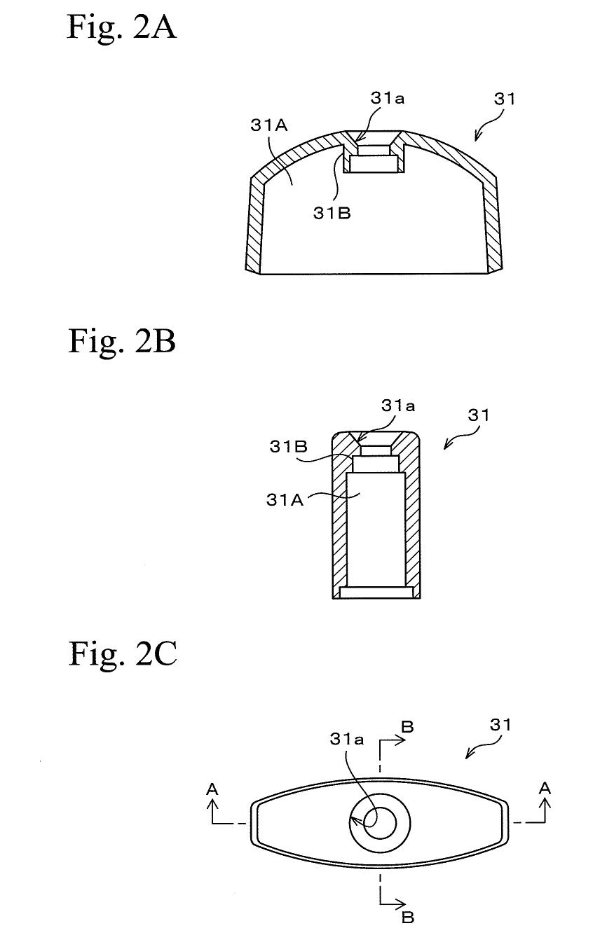

The shell 31 internally has the hollow portion 31A as shown in FIG. 2A. FIGS. 2A to 2C show a schematic structure of the shell 31, and FIG. 2A is a cross section taken on line A-A of FIG. 2C, FIG. 2B is a cross section taken on line B-B of FIG. 2C, and FIG. 2C is a top view. The surface of the center of the shell 31 is formed with a hole 31a which is closely fitted with the screw 33. The inside of the center of the shell 31 is formed with a securing portion (convex portion) 31B which is closely fitted with the attaching portion 32B of the cap 32.

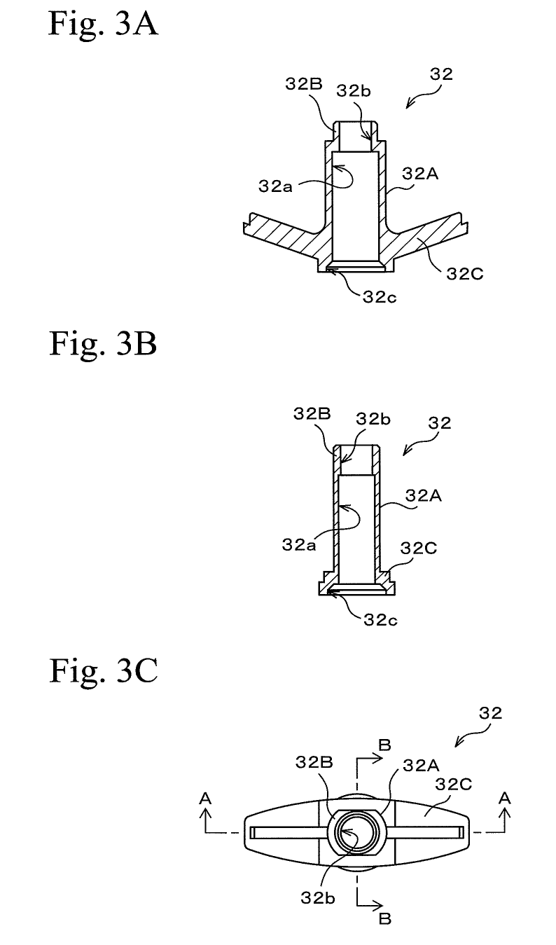

The cap 32 comprises a central portion 32A, an attaching portion 32B integrally formed on the central portion 32A, and a side portion 32C integrally formed on the side of the central portion 32A, which is shown in FIG. 3A to 3C. The attaching portion 32B forms a boss. FIGS. 3A to 3C show a schematic structure of the cap 32, wherein FIG. 3A is a cross section taken on line A-A of FIG. 3C, FIG. 3B is a cross section taken on line B-B of FIG. 3C, and FIG. 3C is a top view. The center of the central portion 32A is formed with a hole 32a in which the attaching portion 23 of the worm gear 20 is slidably inserted. The center of the attaching portion 32B is formed with a hole 32b which has a smaller inner diameter than that of the hole 32a, and a screw 33 is inserted into the hole 32b. The center of the bottom of the side portion 32C is formed with a hole 32c which has a larger inner diameter than that of the hole 32a and has approximately the same diameter as the outer diameter of the upper end of the worm shaft 21. The worm shaft 21 is prevented from sliding above the upper end of the hole 32c by a boundary between the hole 32a and the hole 32c.

The screw 33 is secured to a screw hole of the center of the top of the attaching portion 23 of the worm gear 20 through the hole 31a of the shell 31, the hole 32b and the hole 32a of the cap 32 from the top of the shell 31. Thus, the shell 31 and the cap 32 are closely fitted to each other and are mounted on the worm gear 20.

An end portion of the winding shaft 40 is formed with a winding surface 41 of which the diameter is gradually reduced toward the center thereof. The center of the winding surface 41 is formed with a through-hole 42 into which an end of a string is inserted so that the string may be started to be wound. The top edge of the winding shaft 40 is formed with an attaching shaft 43 which has a small diameter.

A worm wheel 50 is engaged with the worm 22. The bottom of the center of the worm wheel 50 is secured by inserting the attaching shaft 43 of the winding shaft 40 into the supporting hole 11a of the body 10. The worm wheel 50 is mounted on the winding shaft 40 such that the base 11 of the body 10 is held between the worm wheel 50 and the winding shaft 40 by the screw 51.

### 2. Manufacturing Method of the Embodiment

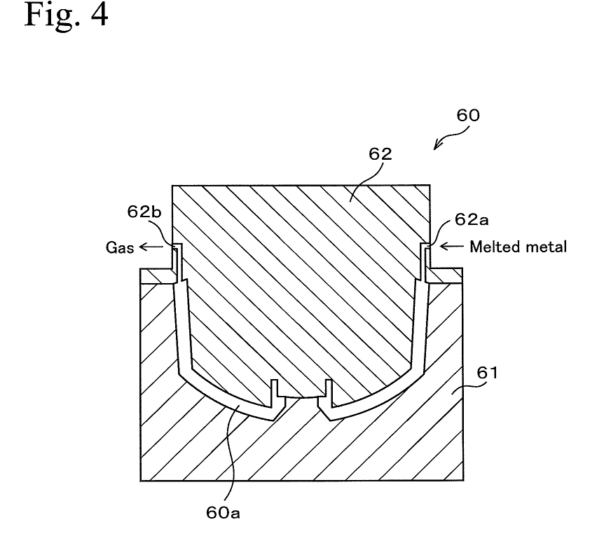

A manufacturing method for the shell 31 of the knob 30 of the peg 1 having the above structure is explained with reference primarily to FIG. 4. FIG. 4 is a sectional side view of a mold 60 for explaining a manufacturing method of the shell 31 of the knob 30 shown in FIGS. 2A to 2C.

The shell 31 is cast by using the mold 60 as shown in FIG. 4. The mold 60 comprises a lower split mold 61 having a concave portion having a shape corresponding to an outer peripheral surface of the shell 31 and an upper split mold 62 with a convex portion having a shape corresponding to an inner peripheral surface of the shell 31. The convex portion of the upper split mold 62 is provided opposing the concave portion of the lower split mold 61 in order to form a cavity 60a. In this case, a sprue 62a is provided at a location at which a bottom surface of the side of the shell 31 is formed on the upper split mold 62, and a gas exhaust port 62b is provided at the other position thereof.

The shell 31 with the hollow portion 31A is formed by using the mold 60 which has the above structure, and melted metal is injected through the sprue 62a. In this case, a separating line formed by the lower split mold 61 and the upper split mold 62 is formed on the bottom surface of the side of the shell 31, and is not conspicuous. The separating line formed at this time has an edge shape that is removable by barrel polishing. Moreover, the sprue 62a may be provided at a location that is not conspicuous, and the mark of the sprue therefore is not conspicuous.

In the peg 1 for a stringed instrument of the present invention, the knob 30 is light in weight and has a reduced wall thickness because the inside of the metal knob 30 is formed as hollow portion 31A. Therefore, responses of vibrations of strings during performances are fast, and tone and afterglow of sounds are good. A high-quality appearance is provided by the metal knob 30. Moreover, the amount of metal material used for the knob 30 can be reduced, whereby manufacturing cost therefor can be reduced. A smaller sprue 62a may be used because a smaller amount of melted metal is required when the knob 30 is cast, and the mark of the sprue formed on the surface of the molded knob 30 can therefore be smaller when the melted metal is injected through the sprue. Furthermore, formation of blowholes caused by gas contained in the knob 30 molded by casting can be inhibited because the wall of the knob 30 is thin. Accordingly, the amount of the gas escaping from the inside of the knob 30 is decreased during plating after casting, and defects of coating can be inhibited. In addition, when polishing is performed by barrel polishing, formation of scratches can be inhibited, even if the knobs strike each other as in the conventional manner, because the knobs 30 are light in weight. Therefore, a large number of knobs may be polished in one barrel polishing, and the manufacturing cost therefor can be further reduced.

### 3. Additional Example

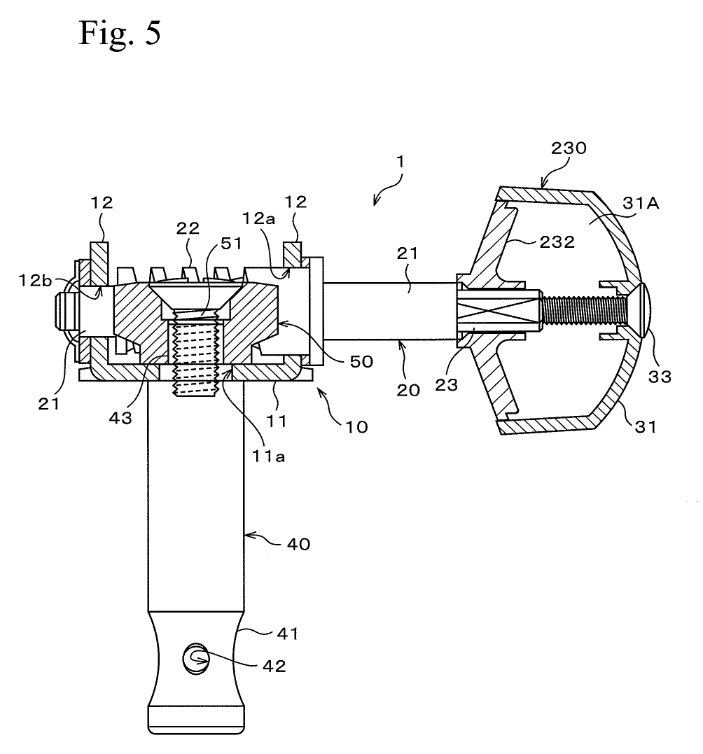

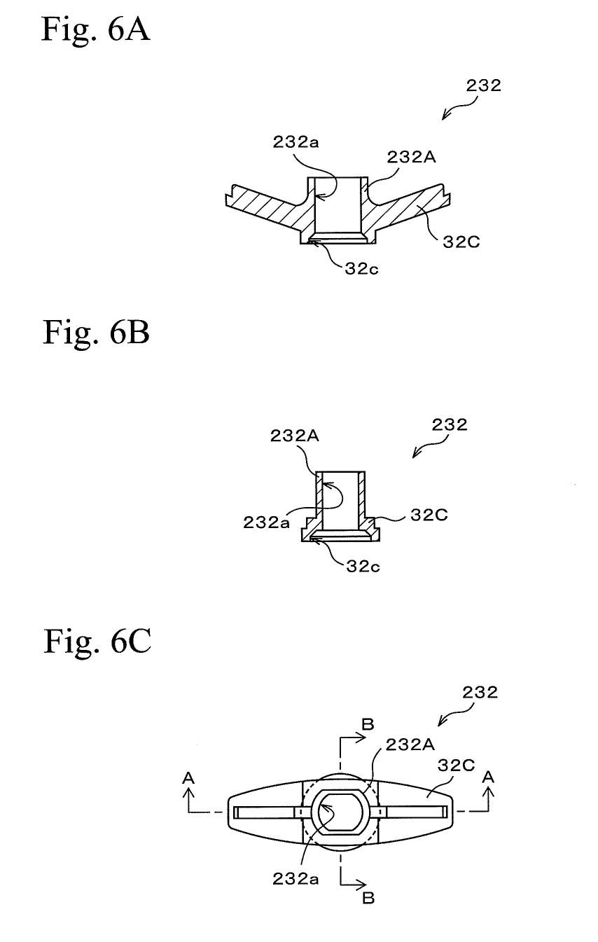

The present invention, as explained with reference to the above embodiment, is not limited thereto, and variations thereof are possible. For example, a knob may comprise at least a hollow portion therein, and the knob is not limited to the knob 30 of the above embodiment. For example, in the above embodiment, the top of a central portion 32A of a cap 32 of the knob 30 is provided with an attaching portion 32B in order to fit the attaching portion 32B to a securing portion 31B of a shell 31A. In one arrangement, a knob 230 as shown in FIG. 5 and FIGS. 6A, 6B, and 6C may be mentioned, in which the top of a central portion 232A of a cap 232 is not provided with the attaching portion 32B as in the above embodiment, and a central portion 232A is formed by reducing the height of the central portion 32A. In this case, the center of the central portion 232A is formed with a hole 232a in which an attaching portion 23 of a worm gear 20 is slidably inserted.

What is claimed is:

1. A peg for a stringed instrument, comprising:
a body provided at a head of the stringed instrument;
a worm gear rotatably provided at the body;
a metal knob provided at an end portion of the worm gear for rotating the worm gear; and
a winding shaft connected to the worm gear in contact with a worm wheel; wherein the knob has a hollow portion therein.

2. The peg for a stringed instrument according to claim 1, wherein the knob comprises:
a shell which is hollow and has an opening at an end; and
a cap removably provided at the opening of the shell.

3. The peg for a stringed instrument according to claim 2, wherein the knob is provided with a screw,
the shell and the cap are formed with a hole, and the screw removably secures the shell and the cap to the end portion of the worm gear through the holes thereof.

4. The peg for a stringed instrument according to claim 3, wherein the end portion of the worm gear is inserted into the hole of the cap and the screw is screwed to the end portion of the worm gear.

5. The peg for a stringed instrument according to claim 4, wherein the cap is provided with a boss which protrudes to an inside of the shell and has the hole.

6. The peg for a stringed instrument according to claim 5, wherein the shell is provided with a protrusion closely fitting into the boss.
